(19) United States
(12) Patent Application Publication
(10) Pub. No.: US 2022/0383530 A1
(43) Pub. Date: Dec. 1, 2022

(54) METHOD AND SYSTEM FOR GENERATING A DEPTH MAP

(71) Applicant: RAMOT AT TEL-AVIV UNIVERSITY LTD., Tel-Aviv (IL)

(72) Inventors: Raja GIRYES, Tel-Aviv (IL); Yotam GIL, Tel-Aviv (IL); Shay ELMALEM, Tel-Aviv (IL); Harel HAIM, Tel-Aviv (IL)

(21) Appl. No.: 17/772,205

(22) PCT Filed: Oct. 27, 2020
(86) PCT No.: PCT/IL2020/051119

§ 371 Date: Apr. 27, 2022

Related U.S. Application Data
(60) Provisional application No. 62/926,502, filed on Oct. 27, 2019.

(51) Int. Cl. G06T 7/593; G06T 7/80

(52) U.S. Cl. CPC G06T 7/593; G06T 7/85; G06T 7/536

(57) ABSTRACT

A system for depth estimation, comprises at least a first and a second depth estimation optical systems, each configured for receiving a light beam from a scene and estimating depths within the scene, wherein the first system is a monocular depth estimation optical system; and an image processor, configured for receiving depth information from the first and second systems, and generating a depth map or a three-dimensional image of the scene based on the received depth information.

### RELATED APPLICATION

This application claims the benefit of priority of U.S. Provisional Patent Application No. 62/926,502 filed on Oct. 27, 2019, the contents of which are incorporated herein by reference in their entirety.

### FIELD AND BACKGROUND OF THE INVENTION

The present invention, in some embodiments thereof, relates to depth estimation and, more particularly, but not exclusively, to a method and system for generating a depth map.

The generation of 3D images is conventionally done by adding a depth map, providing information on the depth of the pixel within the image and thus providing 3D information. Recovering 3D information from images is one of the fundamental tasks relating to 3D imaging. One way of computing a depth map is to use stereovision. This technique is called “passive” because it can be employed in ambient light conditions. Another passive technique is called “depth from defocus.” In this technique, a variable lens is used to sweep the focal plane through the scene, and to determine at which focus position each object is most sharply observed.

Another method is the so-called Time-of-Flight (ToF) principle. Light is transmitted towards the scene, and the camera measures the time delay between the transmitted and received light. As light propagates at a fixed speed, one can measure distances with this method. This technique is called “active” since it requires light other than the ambient light. Another active technique is called “structured light”. The technique is based on the observation that a stripe projected on a non-planar surface intersects the surface at a curve which can reflect the characteristic of surface. An image of the curve can be acquired by an imaging device imaged to form a plurality of measured points on the plane of imaging device, referred to as the imaging plane. The curve and the light source producing the stripe define another plane referred to as the light plane. There is a projected correspondence between points on the light plane and points on the imaging plane. Based on the projected correspondence the 3D coordinates of the points on the non-planar surface can be determined. In order to acquire image of the entire surface, coded patterns are projected instead of a single stripe, hence the terms “structured light” or “coded light.”

### SUMMARY OF THE INVENTION

According to an aspect of some embodiments of the present invention there is provided a system for depth estimation. the system comprises: at least a first and a second depth estimation optical systems, each configured for receiving a light beam from a scene and estimating depths within the scene, wherein the first system is a monocular depth estimation optical system; and an image processor, configured for receiving depth information from the first and second systems, and generating a depth map or a three-dimensional image of the scene based on the received depth information.

According to some embodiments of the invention the system wherein the image processor is configured for fusing depth maps estimated by the first and the second system.

According to some embodiments of the invention the fusing is by thresholding wherein the image processor is configured for receiving depth estimations that are less than a predetermined depth threshold from the first system, and other depth estimations from the second system.

According to some embodiments of the invention the image processor is configured for calculating confidence values for depth estimations provided by the first and the second systems, wherein the fusing is based on the calculated confidence values.

According to some embodiments of the invention the calculating comprises applying a machine learning procedure.

According to some embodiments of the invention the first system comprises a lens, an optical mask, and an image processor, wherein the optical mask is characterized by at least one parameter, and wherein the image processor is configured for extracting from an image captured through the mask depth cues corresponding to the at least one parameter, and for estimating a depth map of the scene based on the extracted depth cues.

According to some embodiments of the invention the second system comprises a passive depth estimation system. According to some embodiments of the invention the second system comprises a stereoscopic imaging system. According to some embodiments of the invention the second system comprises a light field imaging system.

According to some embodiments of the invention the second system comprises an active depth estimation system. According to some embodiments of the invention the second system comprises a structured light imaging system. According to some embodiments of the invention the second system comprises a time-of-flight imaging system.

According to some embodiments of the invention the first system is selected from the group consisting of a light field imaging system, a structured light imaging system, and a time-of-flight imaging system, and the second system comprises a stereoscopic imaging system.

According to some embodiments of the invention the second system comprises a stereoscopic imaging system generating a left image and a right image, wherein the image processor is configured for rectifying one of the left and right images, but not another one of the right images.

According to some embodiments of the invention the image processor is configured for calibrating depth estimations of the second system using depth estimations received from the first system.

According to some embodiments of the invention the second system comprises a stereoscopic imaging system, wherein the image processor is configured for calculating consistency losses among depth maps estimated by the first and the second systems, and wherein the calibrating is based on the calculated consistency losses.

According to some embodiments of the invention the at least one of the first and the second systems comprises a Dynamic Vision Sensor (DVS).

According to some embodiments of the invention the calibrating comprises selecting a rectification procedure that reduces the consistency losses.

According to some embodiments of the invention the second system comprises a stereoscopic imaging system, wherein the image processor is configured to calculate consistency losses among depth maps estimated by the first and the second systems, and to generate an alert signal when the consistency losses are above a predetermined threshold.

According to an aspect of some embodiments of the present invention there is provided a method of depth estimation. The method comprises: receiving a light beam from a scene and estimating depths within the scene, by two different depth estimation techniques, wherein at least one of the depth estimation technique is a monocular depth estimation technique; and receiving depth information estimated by the two different depth estimation techniques, and generating a depth map or a three-dimensional image of the scene based on the received depth information.

According to some embodiments of the invention the method comprises fusing depth maps estimated by the two different depth estimation techniques.

According to some embodiments of the invention the fusing is by thresholding wherein the generating comprises using the monocular depth estimation technique for estimating depths that are less than a predetermined depth threshold, and using another one of the two different depth estimation techniques for estimating other depths.

According to some embodiments of the invention the method comprises calculating confidence values for depth estimations provided by the two different depth estimation techniques, wherein the fusing is based on the calculated confidence values.

According to some embodiments of the invention the calculation comprises applying a machine learning procedure.

According to some embodiments of the invention the estimation of the depths by the monocular depth estimation technique comprises operating a system having a lens, an optical mask, wherein the optical mask is characterized by at least one parameter, and the method comprises extracting from an image captured through the mask depth cues corresponding to the at least one parameter, and estimating a depth map of the scene based on the extracted depth cues.

According to some embodiments of the invention at least one of the depth estimation techniques comprises a passive depth estimation technique. According to some embodiments of the invention the passive depth estimation technique comprises stereoscopic depth estimation. According to some embodiments of the invention the passive depth estimation technique comprises light field imaging.

According to some embodiments of the invention at least one of the depth estimation techniques comprises an active depth estimation technique. According to some embodiments of the invention the active depth estimation technique comprises structured light depth estimation. According to some embodiments of the invention the active depth estimation technique comprises a time-of-flight depth estimation.

According to some embodiments of the invention the monocular depth estimation technique is by a system selected from the group consisting of a light field imaging system, a structured light imaging system, and a time-of-flight imaging system, wherein another one of the depth estimation techniques comprises stereoscopic depth estimation.

According to some embodiments of the invention at least one of the depth estimation techniques comprises stereoscopic depth estimation by a stereoscopic imaging system generating a left image and a right image, and the method comprises rectifying one of the left and right images, but not another one of the right images.

According to some embodiments of the invention the method comprises using depth estimations obtained by the monocular depth estimation technique for calibrating depth estimations obtained by another one of the monocular depth estimation techniques.

According to some embodiments of the invention at least one of the depth estimation techniques comprises stereoscopic depth estimation, wherein the method comprises calculating consistency losses among depths estimated by the two depth estimation techniques, and wherein the calibrating is based on the calculated consistency losses.

According to some embodiments of the invention the calibration comprises selecting a rectification procedure that reduces the consistency losses.

According to some embodiments of the invention at least one of the depth estimation techniques comprises stereoscopic depth estimation, wherein the method comprises calculating consistency losses among depths estimated by two depth estimation techniques, and generating an alert signal when the consistency losses are above a predetermined threshold.

According to an aspect of some embodiments of the present invention there is provided a method of calibrating a stereoscopic imaging system. The method comprises: receiving a stereoscopic image pair having a first image and a second image; applying an image transformer to the first image to rectify the first image to the second image, thereby providing a rectified first image; generating a monocular depth map from the first image; generating a stereoscopic depth map pair having a first depth map corresponding to the rectified first image and a second depth map corresponding to the second image; comparing the monocular depth map to the first depth map; and calibrating the stereoscopic imaging system based on the comparison.

According to some embodiments of the invention the generation of the monocular depth map comprises applying a trained machine learning procedure to the first image.

According to some embodiments of the invention the generation of the stereoscopic depth map pair comprises applying a trained machine learning procedure to the rectified first image and the second image.

According to some embodiments of the invention the comparison comprises calculating a consistency loss among the monocular depth map and the first depth map.

According to some embodiments of the invention the calibration comprises adjusting at least one parameter of the image transformer so as to reduce the calculated consistency loss.

According to some embodiments of the invention the calibration comprises adjusting at least one parameter of the image transformer so as to increase matching between the monocular depth map and the first depth map.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a mono-stereo system used in experiments performed according to some embodiments of the present invention.

FIG. 2 is a schematic illustration of a simulation performed according to some embodiments of the present invention. A left image is fed to a Differentiable Projective Transformation (DPT) and rectified to a right image. The rectified image and the right image are then processed in both the stereo and the monocular networks. For calibration, the system learns the projective transformation which provides the best consistency between the monocular and stereo left depth maps. For depth map fusion, the right depth maps of the stereo and monocular images are fused into a more accurate depth map with an extended range.

FIGS. 3A and 3B show normalized L1 difference between the mono and stereo depth maps obtained in experiments performed according to some embodiments of the present invention by rotating an image over two axes.

FIG. 4 shows mean absolute percentage error of absolute depth estimation of stereo with a 10 cm baseline and a phase-coded mono focused at 0.7 m, on a large labeled dataset, obtained in experiments performed according to some embodiments of the present invention.

FIGS. 5A-D are images of a prototype system assembled according to some embodiments of the present invention.

FIG. 6 is a set of images showing depth estimation of real-world images after calibration using a phase-coded depth estimation, according to some embodiments of the present invention.

FIG. 7 is a set of images showing auto-calibration examples using the image-based monocular method, according to some embodiments of the present invention.

FIG. 8 shows a normalized minimum, maximum and mean training loss for a KITTI raw dataset per epoch, for 100 gradient steps, as obtained in experiments performed according to some embodiments of the present invention.

FIG. 9 is a set of images showing auto-calibration applied to the KITTI raw dataset, as obtained in experiments performed according to some embodiments of the present invention.

FIG. 10 is a set of images showing examples of fusion of stereo and mono depth maps, as obtained in experiments performed according to some embodiments of the present invention.

FIG. 11 is a set of images showing online-calibration results on a dataset synthetic images, as obtained in experiments performed according to some embodiments of the present invention.

FIG. 12 is a set of images showing examples of online-calibration results on real-world images, using cameras mounted on a rigid base with a known baseline, as obtained in experiments performed according to some embodiments of the present invention.

FIG. 13 is a set of images showing additional Examples of calibration on the KITTI uncalibrated dataset obtained in experiments performed according to some embodiments of the present invention.

FIG. 14 is a set of images, obtained in experiments performed according to some embodiments of the present invention, and showing examples of online-calibration on real-world images, after calibrating with a checkerboard target, and applying a 2-degree rotation on the calibrated results.

FIG. 15 is a schematic illustration of a system for depth estimation, according to some embodiments of the present invention.

FIG. 16 is a schematic illustration of an imaging system suitable for serving as a passive phase-coded depth estimation system, according to some embodiments of the present invention.

### DESCRIPTION OF SPECIFIC EMBODIMENTS OF THE INVENTION

The present invention, in some embodiments thereof, relates to depth estimation and, more particularly, but not exclusively, to a method and system for generating a depth map.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The Inventors found that while active methods achieve more accurate results, they consume more power and generally require complex and expensive hardware, a complicated calibration process and achieve relatively low spatial resolution. The Inventors also found that while passive methods are usually based on cheaper hardware, they require higher computational efforts and achieve less accurate results compared to active methods.

The Inventors have therefore devised an improved framework for generating a depth map, which can optionally and preferably be used for producing a three-dimensional image. The method according to preferred embodiments of the present invention combines a stereo vision technique with a monocular depth estimation technique, such as, but not limited to, a monocular phase-coded aperture technique.

Stereo vision aims at finding correspondence between two rectified images captured by an imaging system having two cameras in order to estimate the disparity map between these two images. In stereo vision techniques, a calibration process is executed before the rectification. In conventional stereo vision techniques, the calibration process is supervised and typically involves capturing several images of a known calibration pattern (such as a checkerboard target). Such a process can be done during camera fabrication, but needs to be repeated after each change in the physical structure of the imaging system, for example, due to an intentional or accidental movement of one or both of the cameras. It was found by the present Inventors that depths that are estimated by stereo vision techniques are very sensitive to calibration errors, and are also sensitive to occlusions. Conventional stereo vision techniques typically estimate depth in the proximate range due to large disparities.

A monocular depth estimation according to some embodiments of the present invention aims at finding depth cues, which can be either global (such as perspective and shadows) or local (focus/out-of-focus). In various exemplary embodiments of the invention no calibration is performed when executing the monocular depth estimation. In preferred embodiments of the invention, a monocular camera suitable for monocular depth estimation includes an optical mask incorporated in the monocular camera exit pupil (or any of its conjugate optical surfaces). The mask is characterized by or more parameters, such as, but not limited to, a geometrical parameter (e.g., a radius, in cases in which the mask has a ring pattern) and a phase-related parameter. A light beam from a scene passes through the mask and the lens of the camera to produce an optical image. The mask blurs the optical image based on the parameters thus encoded the parameters in the image. The parameters serve according to preferred embodiments of the present invention as depth related cues in the image. The cues can be extracted by digital image processing. The digital image processing optionally and preferably comprises a trained machine learning procedure, more preferably a deep learning procedure, such as, but not limited to, a Convolutional Neural Network (CNN). The machine learning procedure is trained to generate a depth map of the scene based on the extracted cues. It was found by the inventors that such a monocular depth estimation based on embedded parameters is more accurate than an estimation based on perspective and shadows.

In a preferred embodiment, the monocular depth estimation is executed at proximity to the focal plane of the lens of the camera that is used for the depth estimation. For example, when the monocular depth estimation is by encoding parameters into the image using the optical mask, the monocular depth estimation is optionally and preferably executed at depths corresponding to a defocus condition ψ, as defined below, of from about −3 to about 11, more preferably from about −4 to about 10.

It is recognized that passive depth reconstruction can be performed using either a stereo or a monocular system. Yet, it was found by the present Inventors that using a stereo is less effective at close ranges and requires the two cameras to be accurately calibrated, and that a monocular system can achieve better results in part of the range. The present embodiments thus provide a two-camera system, in which the cameras are used jointly to extract a stereo depth map, and individually to provide a monocular depth map from one of the cameras or from each of the two cameras.

In some embodiments of the present invention one of the monocular depth maps is utilized for generating a depth map fusion between the monocular depth map and the stereo depth map. In experiments performed by the Inventors it was found that the combination of a stereo depth map with a monocular depth maps provides a depth estimation that is more accurate than the depth estimation of each map.

In some embodiments of the present invention one of the monocular maps is utilized for a self-calibration procedure that is applied to increase the consistency between the monocular and stereo maps. The self-calibration procedure is optionally and preferably executed by a machine learning procedure.

As used herein the term “machine learning” refers to a procedure embodied as a computer program configured to induce patterns, regularities, or rules from previously collected data to develop an appropriate response to future data, or describe the data in some meaningful way.

Representative examples of machine learning procedures suitable for the present embodiments, include, without limitation, clustering, association rule algorithms, feature evaluation algorithms, subset selection algorithms, support vector machines, classification rules, cost-sensitive classifiers, vote algorithms, stacking algorithms, Bayesian networks, decision trees, neural networks, convolutional neural networks, instance-based algorithms, linear modeling algorithms, k-nearest neighbors (KNN) analysis, ensemble learning algorithms, probabilistic models, graphical models, logistic regression methods (including multinomial logistic regression methods), gradient ascent methods, singular value decomposition methods and principle component analysis. In some embodiments of the present invention the machine learning procedure is a deep learning procedure.

A machine learning procedure suitable for the self-calibration according to some embodiments of the present invention is optionally and preferably a semi-supervised calibration procedure. The procedure is semi-supervised in the sense that it needs no ground truth of the real depth of the scene, but it uses a machine learning procedure that was previously trained with depth ground truth. When one of the monocular maps is utilized for self-calibration, there is optionally and preferably an overlap of at least 20% or at least 30% or at least 40% or at least 50% or more between the range of depths estimated by the monocular depth map and the range of depths estimated by the stereo depth map.

When both cameras of the system provide a monocular depth map, one of these monocular depth map is optionally and preferably used for self-calibration, and the other one of these monocular depth map is optionally and preferably used for the depth map fusion.

When both cameras of the system provide a monocular depth map, one of the cameras, or both cameras, includes an optical mask incorporated in the monocular camera exit pupil or any of its conjugate optical surfaces. Alternatively, one or both of the cameras can generate a monocular depth map by a technique other than a technique that is based on an optical mask. Such a technique can employ a passive depth estimation system (e.g., a light field imaging system), or an active depth estimation system (e.g., a structured light imaging system, a time-of-flight imaging system).

The present embodiments thus provide a depth estimation system, which combines monocular and stereo vision depth maps for achieving superior depth estimation. The depth estimation system allows an online self-calibration in a semi-supervised manner.

Some embodiments of the present invention utilize two or more active or passive depth estimation systems of different types (e.g., selected from the group consisting of a mask based depth estimation system, a light field imaging system, a structured light imaging system, and a time-of-flight imaging system), but without employing stereo depth estimation. Each system can provide a depth map using a different technique, and the two or more depth maps can be combined (e.g., fused) to improve the accuracy of the depth estimation.

The technique of the present embodiments can also be used for capturing a sequence of images with a single phase-coded camera from different points of view. Auto-calibration in accordance with some embodiments of the present invention can then be applied to provide a fast and reliable method for calibrating each image pair, in order to produce a full 3D model of the captured scene.

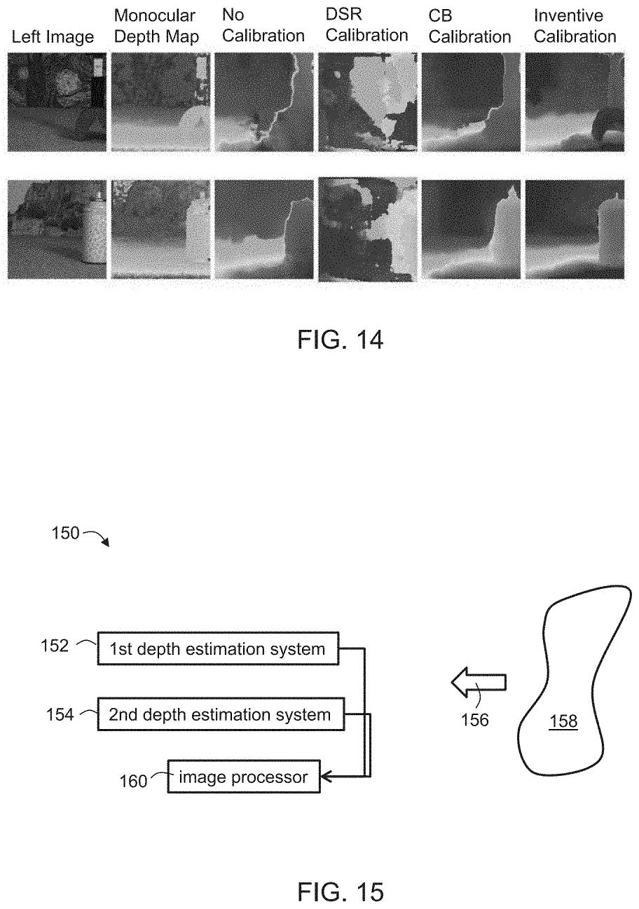

Referring now to the drawings, FIG. 15 illustrates a system 150 for depth estimation, according to some embodiments of the present invention. System 150 comprises two or more depth estimation optical systems 152, 154, each configured for receiving a light beam 156 from a scene 158 and estimating depths within scene 158. While FIG. 15 shows only two depth estimation optical systems, it is to be understood that the present embodiments contemplate using also more than two depth estimation optical systems.

One or more, more preferably each, of the depth estimation optical systems comprises an image sensor. In these embodiments, the respective depth estimation optical system can be a camera. The image sensor can be of any type known in the art. Representative examples include, without limitation a complementary metal oxide semiconductor (CMOS) image sensor, charge-coupled-device (CCD), Dynamic Vision Sensor (DVS), a vidicon, a plumbicon, and the like.

In various exemplary embodiments of the invention at least two of the depth estimation optical systems employ different depth estimation techniques. Preferably, one of the depth estimation optical systems (e.g., system 152) is a monocular depth estimation optical system, employing monocular depth estimation. Any type of passive or active monocular depth estimation can be employed by system 152. Representative examples of passive depth estimation that can be employed by system 152 include, without limitation, image-based depth estimation, and phase-coded depth estimation. Also contemplated is monocular depth estimation from signals received from a DVS, for example, by integrating information from a sequence of events captured by the DVS. Additional passive depth estimation techniques using DVS are described in the literature, see, for example, “Event-based Vision: A Survey”, by Gallego et al., DOI: 10.1109/TPAMI.2020.3008413.

As used herein, “passive image-based depth estimation” refers to a technique in which depths within the scene are estimated based, at least in part, and more preferably exclusively, on the structure of the scene itself (e.g., proportions, vanishing lines, etc.). In some embodiments of the present invention passive image-based depth estimation includes a machine learning procedure that has been trained on training monocular depth datasets. A passive image-based depth estimation suitable for the present embodiments is found in [Lasinger et al. 2019].

As used herein, “passive phase-coded depth estimation” refers to a technique in which depths within the scene are estimated by receiving light from the scene through a phase coded mask to provide an image, wherein the phase coded mask embeds depth related cues in the image. In some embodiments of the present invention the cues are extracted by a machine learning procedure, such as, but not limited to, a Convolutional Neural Network (CNN), trained to estimate the scene depth according to those cues. A passive phase-coded depth estimation suitable for the present embodiments is found in international patent application No. WO2019/224823, the contents of which are hereby incorporated by reference.

For example, a passive phase-coded depth estimation can be performed by receiving light from the scene, passing the light through a phase mask that generates a phase shift in the light, capturing an image constituted by the light, processing the image to de-blur the image and/or to generate a depth map of the image. The processing can be by a trained machine learning procedure, by sparse representation, by blind deconvolution, by clustering, or the like.

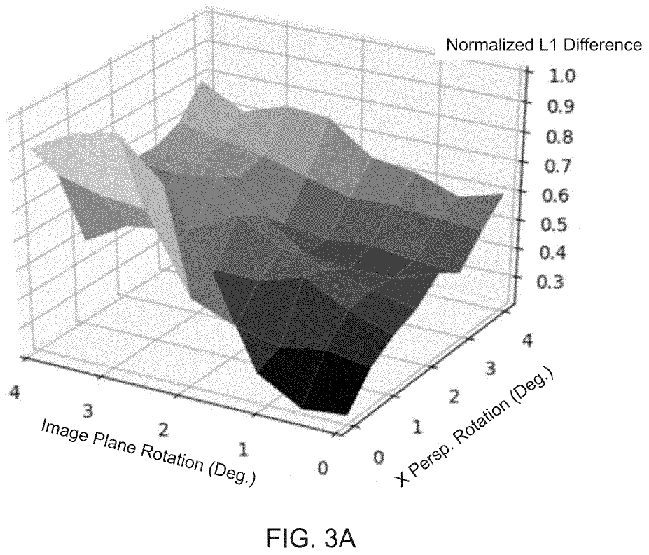

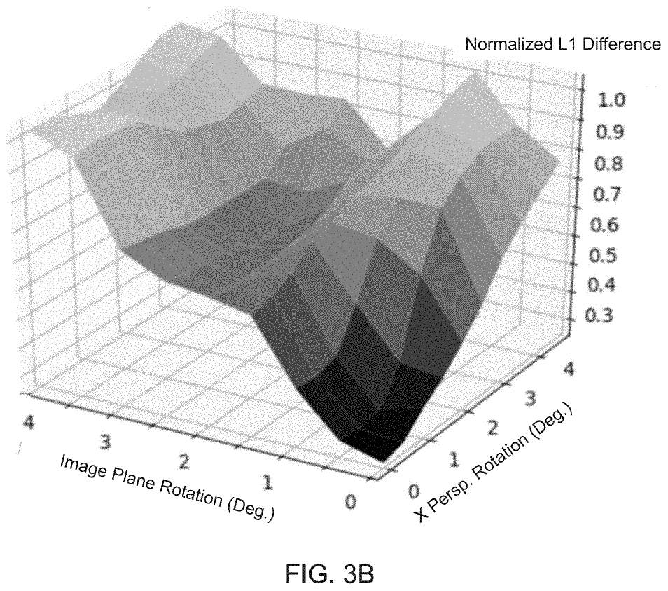

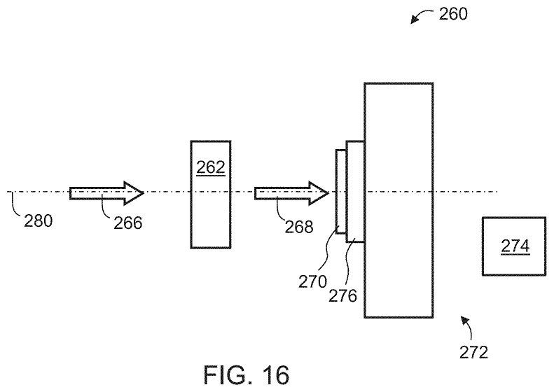

A schematic illustration of an imaging system 260 suitable for serving as passive phase-coded depth estimation system 152, according to some embodiments of the present invention is shown in FIG. 16. Imaging system 260 comprises an imaging device 272 having an entrance pupil 270, a lens or lens assembly 276, and optical element 262, which is preferably a phase mask as further detailed hereinabove. Optical element 262 can be placed for example, on the same optical axis 280 with imaging device 272. While FIG. 3 illustrates optical element 262 as being placed in front of the entrance pupil 270 of imaging system 260, this need not necessarily be the case. For some applications, optical element 262 can placed at entrance pupil 270, behind entrance pupil 270, for example at an exit pupil (not shown) of imaging system 260, or between the entrance pupil and the exit pupil.

When system 260 comprises a single lens, optical element 262, can be placed in front of the lens of system 260, or behind the lens of system 260. When system 260 comprises a lens assembly, optical element 262 is optionally and preferably placed at or at the vicinity of a plane of the aperture stop surface of lens assembly 276, or at or at the vicinity of one of the image planes of the aperture stop surface.

For example, when the aperture stop plane of lens assembly 276 is located within the lens assembly, optical element 262 can be placed at or at the vicinity of entrance pupil 270, which is a plane at which the lenses of lens assembly 276 that are in front of the aperture stop plane create an optical image of the aperture stop plane. Alternatively, optical element 262 can be placed at or at the vicinity of the exit pupil (not shown) of lens assembly 276, which is a plane at which the lenses of lens assembly 276 that are behind the aperture stop plane create an optical image of the aperture stop plane. It is appreciated that such planes can overlap (for example, when one singlet lens of the assembly is the aperture stop). Further, when these are secondary pupils (for example, in cases in which the lens assembly includes many singlet lenses), optical element 262 can be placed at or at the vicinity of one of the secondary pupils.

Optical element 262 can be used for changing the phase of a light beam, thus generating a phase shift between the phase of the beam at the entry side of element 262 and the phase of the beam at the exit side of element 262. The light beam before entering element 262 is illustrated as a block arrow 266 and the light beam after exiting element 262 is illustrated as a block arrow 268. System 260 can also comprises an image processor 274 configured for processing images captured by device 272 through element 262, as further detailed hereinabove.

Representative examples of active depth estimation that can be employed by system 152 include, without limitation, depth estimation by light field imaging, depth estimation structured light imaging, and depth estimation by time-of-flight imaging.

System 154 can employ any depth estimation technique that is different from the depth estimation technique employed by system 152. Preferably, but not necessarily system 154 comprises a passive depth estimation system, such as, but not limited to, a stereoscopic imaging system, a light field imaging system, or the like. Alternatively, system 154 can employ active depth estimation, e.g., depth estimation by structured light imaging, or depth estimation by time-of-flight imaging.

In preferred embodiments of the present invention, system 152 is selected from the group consisting of a light field imaging system, a structured light imaging system, and a time-of-flight imaging system, and system 154 comprises a stereoscopic imaging system.

System 150 further comprises an image processor 160 having a circuit (e.g., a dedicated circuit) that receives depth information from the depth estimation systems 152, 154 and generates a depth map or a three-dimensional image of scene 158 based on the received depth information. In some embodiments of the present invention processor 160 fuses depth maps estimated by systems 152 and 154. Preferably, the fusing is by thresholding, wherein depth estimations that are less than the predetermined depth threshold are obtained from monocular depth estimation optical system 152, and other depth estimations are obtained from system 154. Practically, the thresholding can be executed by generate a binary mask based on the predetermined threshold, and using the binary mask to combine the maps from systems 152 and 154. Since the depth ranges at which each of systems 152 and 154 is more accurate is generally known a priori, the threshold can be set in advance to achieve best accuracy in the overall depth map. The advantage of using such a predetermined threshold is that in is not affected by generalization issues. This is advantageous over a technique in which the combination of depths from the two systems is based on the scene itself.

In some embodiments of the present invention processor 160 calculates confidence values for depth estimations provided by systems 152 and 154. In these embodiments, the fusion between the depth maps is based on the calculated confidence values. Thus, for example, for each picture-element (e.g., pixel) of the fused depth map, the depth value can be the depth value of the depth estimation system for which the confidence values for that particular picture-element was the highest. Confidence values can be calculated, for example, by a machine learning procedure.

When system 152 comprises a mask (e.g., when system 152 is embodied as the system 260) its image processor is optionally and preferably configured for extracting from an image captured through the mask depth cues corresponding to the parameter that characterizes the mask (e.g., radius, phase) and for estimating a depth map of scene 158 based on the extracted depth cues.

When system 154 comprises a stereoscopic imaging system, system 154 generates a left image and a right image, and processor 160 optionally and preferably rectifies one of the left and right images, but not the other one of the left and right images.

System 150 can also be used for calibration. In these embodiments, processor 160 optionally and preferably calibrates depth estimations of system 154 using depth estimations received from monocular depth estimation optical system 152. These embodiments are particularly useful when system 154 comprises a stereoscopic imaging system, because such systems are sensitive to extrinsic calibration, so that information obtained from a monocular depth estimation system such as system 152 allows system 150 to perform self-calibration, as demonstrated in the Examples section that follows.

The calibration can be executed, for example, by calculating consistency losses among depth maps estimated by systems 152 and 154, and calibrating system 154 based on the calculated consistency losses. Typically, processor 160 enforces consistency between the depths estimated by systems 152 and 154 so as to find the transformation required for calibrating system 154. In some embodiments of the present invention, when the calculated consistency loss is above a predetermined threshold, processor 160 can generate an alert signal.

A calibration procedure suitable for the present embodiments can include receiving from the stereoscopic imaging system 154 an image pair having a first image and a second image. The first image of a pair can be fed to an image transformer, so as to rectify it to the second image, thereby providing a rectified first image. The first image of a pair can be separately processed to provide a monocular depth map. The rectified first image and the (unrectified) second image can then be processed collectively to generate a stereoscopic depth map pair having a first depth map corresponding to the rectified first image and a second depth map corresponding to the second image. The monocular depth map generated from the first image, and the first depth map of the stereoscopic depth map pair can be compared, and the stereoscopic imaging system 154 can then be calibrated based on the comparison. The calibration typically includes adjustment of one or more parameters of the image transformer so as to improve the matching between the two maps. The comparison between the maps is a quantitative comparison. For example, in some embodiments of the present invention the comparison comprises calculating a consistency loss among the monocular depth map and the first depth map of the stereoscopic depth map pair. In these embodiments, the parameters of the image transformer are adjusted so as to reduce the calculated consistency loss.

In some embodiments of the present invention the monocular depth map is generated by applying a first trained machine learning procedure to the first image, and in some embodiments of the present invention the stereoscopic depth map pair is generated by applying a second trained machine learning procedure to the rectified first image and the (unrectified) second image. When machine learning procedures are used for generating the depth maps, the parameters of the machine learning procedures are optionally and preferably kept frozen, and the adjustment is only of the parameters of the image transformer.

The image transformer can employ any spatial transformation known in the art, including, without limitation, Affine Transformation (e.g., Piecewise Affine Transformation), Projective Transformation, Spline Transformation (e.g., Thin Plate Spline Transformation), and the like. In preferred embodiments, the image transformer is by itself trained machine learning procedure, such as the so called Spatial Transformer Network (STN). STN is a known technique for applying spatial transformation to input images, and is described, for example, in [Jaderberg et al., 2015], the contents of which are hereby incorporated by reference. Briefly, STN feeds an input image to a localization network such as, but not limited to, a fully-connected network, a convolutional network, etc, that outputs a transformation parameter. The STN also applies a sampling kernel to the input image, and generates a parameterized sampling grid. A transformation characterized by the obtained transformation parameter is then applied to the picture-element over the parameterized sampling grid, to provide a transformed image. The applied transformation is optionally and preferably differentiable with respect to the parameter of the transformation. Representative examples of transformations suitable for the present embodiments include, without limitation, projective transformation, attention transformation, affine transformation, thin plate spline transformation, and the like. In a preferred embodiment, the transformation is projective transformation. In this embodiment, the operation performed by the image transformer is referred to as a Differentiable Projective Transformation (DPT).

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

Stereo imaging is the most common passive method for producing reliable depth maps, however, it has larger error in the very short range due to correspondence ambiguity, and is sensitive to extrinsic calibration. This Example describes a framework to overcome these limitations, in accordance with some embodiments of the present invention. This Example demonstrates how a stereo depth-map can be improved by equipping one of the stereo cameras with a phase-coded mask, which provides depth information for the range of depths in which the stereo struggles. A fusion between the depth maps improves the original stereo accuracy by 10%. This Example also presents am online self-rectification approach, which by enforcing consistency between the stereo and monocular depth maps finds the transformation required for the stereo calibration. As will be shown below, this calibration can be performed also without the phase mask by using image-based monocular depth estimation. This eliminates the need for additional optical hardware and extends the usage of our self-calibration scheme for most existing stereo cameras.

While many passive techniques exist, in this Example focuses mainly on stereo imaging, which is the most popular depth estimation strategy, and on monocular methods that use either phase coding or image information.

Stereo Depth Estimation

Stereo vision works in similarity to the depth perception of the human visual system. It uses two points of view to estimate the depth at each pixel by finding the disparity the horizontal displacement of each pixel between the two acquired stereo images. The disparity in location of the same object between two different images serves as an indication of the object's depth. The reconstructed depth's dynamic range and resolution are set by the distance between the two cameras (known as the baseline), the cameras' field of view and the ability to accurately estimate the disparity.

Recently, deep learning (DL) became the main tool to achieve improved stereo depth estimation [Zbontar and LeCun 2015, Luo et al. 2016, Chang and Chen 2018, Cheng et al. 2018, Du et al. 2019, Zhang et al. 2019, Yin et al. 2018, Smolyanskiy et al. 2018.

Most of the known stereo algorithms assume that both images are perfectly rectified, namely that the epipolar lines are horizontal, allowing limiting the search for disparity only on horizontal lines. The transformations required for the images' rectification are achieved using a calibration process, which generally requires taking several images of a known calibration pattern (like a checkerboard target), making the process relatively time-consuming and expensive. In addition, the depth estimation performance is highly sensitive to calibration errors. Thus, a stereo camera design has high sensitivity to various environmental conditions (mechanical shock, vibration, thermal expansion) that can potentially change the setup calibration. Furthermore, in order to maintain the factory-made calibration, many of the stereo cameras sets are mechanically hardened. This dictates baseline constraints that can be avoided using an online self-calibration ability.

Monocular Depth Estimation

Various monocular techniques utilize the global structure of the scene and depth cues like proportion and vanishing lines to achieve depth estimation [Silberman and Fergus 2011, Nathan Silberman and Fergus 2012, Saxena et al. 2009, Eigen et al. 2014, Liu et al. 2016, Garg et al. 2016, Godard et al. 2017, Goldman et al. 2019, Pillai et al. 2018, Guizilini et al. 2019, Poggi et al. 2018, Bhoi 2019]. Such methods achieve only relative depth estimation, and generally with limited performance. Moreover, learning-based methods that rely on global depth cues have limited generalization ability for scenarios different than the dataset used for training.

Other monocular solutions are based on local optical cues. Since the lens response is depth-dependent (due to different behavior for in- and out-of-focus conditions), this feature can be employed for depth estimation [Darrell and Wohn 1988, Schechner and Kiryati 2000, Trouvé et al. 2013, Suwajanakorn et al. 2015, Carvalho et al. 2018, Gur and Wolf 2019, Lin et al. 2013, Lin et al. 2015, Hazirbas et al. 2018, Guo et al. 2017].

A more sophisticated approach employs computational imaging in which a modification is done to the imaging system in order to acquire an optical image that better suits the final application [Malt et al. 2018]. In the case of depth estimation, by coding the lens response in a certain way, the depth-dependent behavior of the optics is intensified, such that the optical depth cues embedded in the image are much stronger.

This work compares and applies both monocular approaches to present the proposed self-calibration ability. Since the phase-coded method is less known and straightforward, we hereby present its basic idea and principles.

Monocular Depth Estimation Using Aperture Phase-Coding

Aperture-coding has the advantage of having a very high light efficiency, with small or no loss. In a preferred aperture-coding technique, a phase aperture-coding mask is used in the image acquisition process [Haim et al. 2018]. Based on the phase-coding mask, a depth- and color-dependent point spread function (PSF) is generated, such that each of the image's RGB channels can be thought of as being optimally focused on a different depth in the scene.

Using the focus and out-of-focus color-depth cues embedded in the image, a neural network can be trained to predict the defocus condition (labeled as ψ) at each pixel. Assuming the lens parameters and focus point are known, the absolute depth can be derived from ψ. The defocus condition ψ is defined as:

$$ψ = \frac{{π R}^{2}}{λ} ( \frac{1}{{z}_{img}} - \frac{1}{{z}_{i}} ) = \frac{{π R}^{2}}{λ} ( \frac{1}{{z}_{o}} - \frac{1}{{z}_{n}} ) ,$$

where R is the radius of the exit pupil (assuming a circular aperture), λ is the illumination wavelength, z_{img} is the sensor plane location for an object in the nominal position zₙ, and zᵢ is the ideal image plane location for an object located at zₒ. As |ψ| increases, the image contrast decreases, hence the contrast is at maximum for ψ=0 (the in-focus position). The mask and procedure can be designed for optimal depth estimation in the range of ψ=−4 to ψ=10.

Multi-Sensor Depth Map Fusion

A known technique for fusing depth maps from different views averages truncated signed distance functions [Curless and Levoy 1996]. However, this technique is based on a simple uniform weighted averaging, and therefore it does not account for different sensors characteristics, such as different noise distribution. Other techniques employ Gaussian distribution to model a sensor noise or learn the error distribution from the data itself [Kim et al. 2009, Riegler et al. 2017]. Also known, is the fusion of stereo and ToF methods [Nair et al. 2013, Zhu et al. 2011, Hahne and Alexa 2008].

The technique in this Example is different than those techniques since it allows fusing completely two different sensors by setting a threshold to create a binary mask and fuse the two depth maps with the binary mask. The threshold is optionally and preferably set according to the depth range accuracy of each of the monocular and stereo methods.

### Method

Stereo Camera Online Self-Calibration

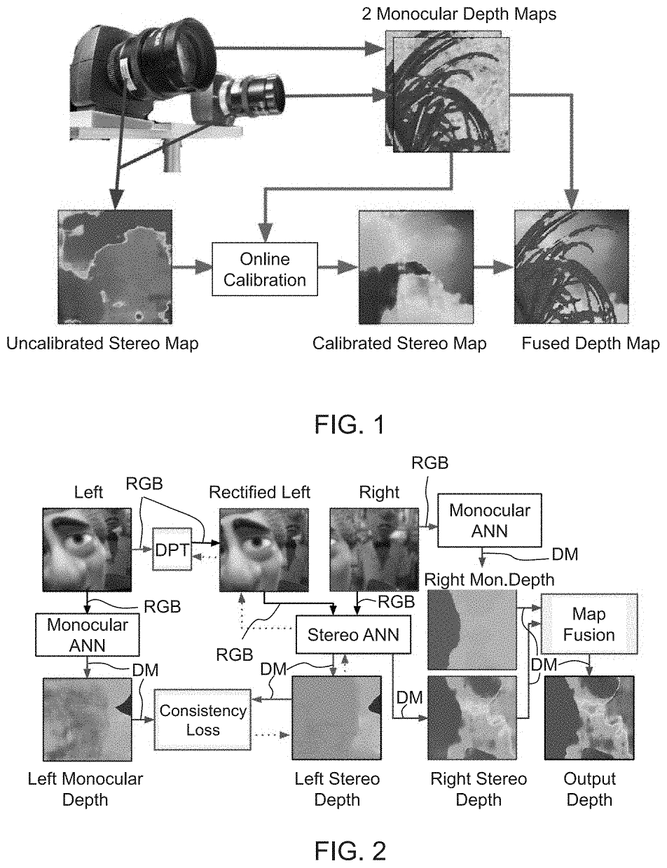

FIG. 1 is a schematic illustration of a mono-stereo system used in this Example according to some embodiments of the present invention. The system provides an extended range in depth estimation and an effective online calibration. Images acquired in a non-calibrated system provide a wrong depth map. By combining stereo and monocular techniques, the solution of the present embodiments performs an automatic calibration, and it improves the overall depth reconstruction mitigating some deficiencies in stereo (close-range errors) and mono (noisy far range). In this Example, the left camera is equipped with a mask for the phase-coded method. The system uses the stereo set left camera's image for monocular depth estimation, and both the left and the right cameras' images for the stereo depth estimation.

FIG. 2 is a schematic illustration of a simulation performed according to some embodiments of the present invention. A left image is fed to a Differentiable Projective Transformation (DPT) and rectified to a right image. The rectified image and the right image are then processed in both the stereo and the monocular networks. For calibration, the system learns the projective transformation which provides the best consistency between the monocular and stereo left depth maps. For depth map fusion, the right depth maps of the stereo and monocular images are fused into a more accurate depth map with an extended range. The arrows representing RGB input are designated “RGB”, arrows representing depth map input are designates “DM” and arrows representing back-propagation path are dotted.

Since the DPT rectified the left image of the stereo pair to the right image, the depth map reconstruction was performed from that perspective. Since the monocular depth estimation has no requirement for an extrinsic calibration process, it can be used as a reliable source for self-calibration of the stereo camera set, by requiring consistency between the monocular and stereo depth maps, and training the DPT parameters accordingly. These parameters are learned by back-propagating the consistency loss through the pre-trained stereo network. The consistency loss is an L1-loss between the monocular and the stereo networks' output.

Comparing to stereo calibration using image local-features methods, the use of pre-trained networks exploits the global context understanding gained by the networks during their training. The use of differentiable transformation allows an end-to-end training that achieves a closed-loop calibration solution based on the output depth maps.

The underlying assumption in this Example is that consistency between the two sources of depth maps (mono and stereo) would be optimal when the stereo setup is calibrated, as the stereo depth map would be most accurate. This assumption was empirically tested by examining the L1 difference between the stereo and mono depth maps for various calibration errors. For the sake of visualization, two rotation axes were selected: image plane rotation and X-axis perspective rotation. The right image was rotated along the axes and the L1-difference between the perceived mono and stereo depth maps was calculated.

The obtained normalized L1 difference is shown in FIG. 3A for the image-based monocular method and in FIG. 3B for the phase-coded monocular method. Notice that in both methods, the minimal difference is achieved when both angles are zero. Since the error surface in the phase-coded method is generally smoother compared to the image-based method, it usually leads to a better calibration result. This finding is also evident in the experimental results described below.

The DPT can be applied either on the left or the right image in the input stage of the stereo network. The DPT can learn the required transformation parameters to rectify one image to the other image. In this Example, the DPT block has 8 degrees-of-freedom (DoF), that can perform unconstrained projective transformation. The trained transformation is applied and the transformed image is interpolated using a bilinear interpolation.

For the self-calibration process, both the weights of the pre-trained stereo and mono depth networks are frozen, and only the DPT parameters are trained in order to rectify the images in the non-calibrated stereo setup. This training can be considered semi-supervised, as it needs no ground truth of the real depth of the scene. Yet, it uses pre-trained networks previously trained with depth ground truth.

For calibration using the phase-coded method it is advantageous to have a scene with a specific depth range in it. Preferably, a plurality of the pixels in the image used for calibration, and more preferably most of the pixels in this image, are within the depth range spanning over a range of the defocus condition _{w} that is set by the lens parameter and focus point. This allows a sufficient amount of accurate features in the depth maps for comparison. In this Example, most of the pixels in the image used for calibration were within the depth range spanning from ψ=−4 to ψ=10. Assuming the focal point of phase-coded camera is accurately known, the depth map produced is in absolute metric, and so no alignment between the depth maps was necessary, achieving a calibration of the system.

For the image-based only monocular method, the calibration is possible for every depth range that the monocular network was trained upon, or can generalize to. Since the image-based monocular method produces a relative (rather than an absolute) depth map, the depth maps were aligned by multiplying with the median value of the stereo prediction and dividing by the median value of the monocular prediction. Since the image-based method produces relative depth maps, the x-translation parameter in the projective transformation in these experiments was fixated, so that the depth map perceived was absolute, according to the known stereo baseline. This was done under the assumption that the baseline was known and more robust. Relaxing this assumption would lead to a rectification rather than calibration, and a relative depth map.

The self-calibration process may be done in more than one way. In some embodiments of the present invention the calibration is initiated by the user. In these embodiments, the user captures a set of left and right images, and then initiates the training process of the DPT parameters accordingly. In some embodiments of the present invention the calibration is performed offline. In these embodiments the system automatically chooses recently captured images that are proper for calibration (e.g., an image with most of the pixels in the monocular depth range), and fine-tunes the current calibration using these images.

An advantage of this approach is that it can indicate whether the system is out-of-calibration by noticing a decrease in the monocular and stereo depth map consistency, and alerting the user that a calibration process is required.

Improving Depth Estimation

Stereo vision suffers from high error in proximate ranges due to large disparity values. This error is even more prominent in terms of relative error. Phase-encoded monocular depth estimation is most accurate at or near its focus point. Thus, by setting its focus point to a close depth its depth estimation can be used to improve the stereo depth estimation. In the following, depth-map enhancement is described only with respect to the phase-coded monocular method, but it is to be understood that any technique for monocular depth estimation can be used for the enhancement.

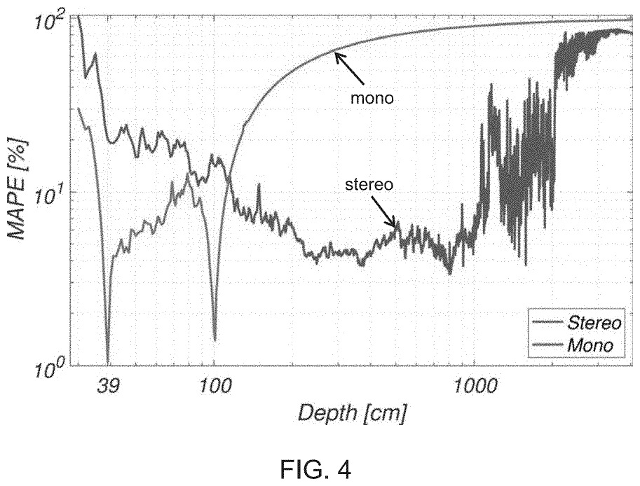

FIG. 4 shows mean absolute percentage error of absolute depth estimation of stereo with a 10 cm baseline and a phase-coded mono focused at 0.7 m, on a large labeled dataset. As shown, the monocular method shows superior depth estimation in the range of 0.39-1.0 m, and the stereo shows superior depth estimation at the farther distances. Thus, a phase-coded monocular approach can be used to improve depth estimation in the close ranges. In addition, this allows decreasing the maximal disparity search space of the stereo method, thereby improving stereo depth estimation accuracy in other ranges. The integration between the monocular and the stereo depth maps is optionally and preferably done with a fusion threshold that merges the depth maps with a binary mask, according to a threshold, that in this Example was set manually, but can also be set automatically or be predetermined. The threshold was selected according to the depth ranges spread by the phase-coded ψ parameter.

The depth reconstruction was performed by fusing the output of two artificial neural networks (ANN), one neural network for stereo depth estimation and one neural network for monocular depth estimation (see FIG. 2). To increase the monocular depth accuracy for the close range, the focus points for the right camera was set to be 0.7 m, which spreads the range of possible predicted distances to 0.39-1 m.

A large set of 500 pairs of stereo images with their depth ground-truth was used to estimate the error in both methods. As a precise full ground truth is rarely attainable in real scenes, simulated data were used. The data was generated using Blender software, and includes left and right RGB images, and a precise dense depth map. The results in FIG. 4 are presented in Mean Absolute Percentage Error (MAPE). As shown in FIG. 4, the monocular camera focused at 0.7 m achieves superior depth estimation in the range of 0.39-1.0 m over the stereo method with a baseline of 10 cm. Thus, the monocular depth estimation can help improving the stereo depth map in this proximate range. The monocular depth map acquired from the second camera (containing information of a broader depth range) was used as a reference for calibrating the stereo setup, as described above.

Since the physical characteristics of the system, particularly the structure of the phase-coded mask, is known, the range in which the estimated ψ parameter is more accurate is also known. Thus a predetermined threshold to decide whether a depth prediction should be taken from the stereo or from the mono depth map was set based on the known range in which the estimated ψ parameter is more accurate. Unlike fusion with a neural network, the predetermined threshold employed herein generalizes to every scene, as it is based on the physical characteristics of the system, rather than the semantics of the scene.

### Experiments

One pre-trained stereo network, and two types of monocular depth estimation networks were used in this Example. The stereo network (referred to herein as network 1) is described in [Chang and Chen 2018], the contents of which are hereby incorporated by reference. This network consists of two Spatial Pyramid Pooling (SPPs) modules with shared weights, one for each image that extracts features from each image in four scales, into a 4D cost-volume. The cost volume is then fed to a 3D-CNN that consists of stacked hourglass modules, up-sampling and regression layers, to achieve an accurate stereo depth map. The network uses atrous convolution to exploit the scene's global context. One type of monocular depth estimation network (referred to herein as network 2) is the phase-encoded monocular network described in [Haim et al. 2018], the contents of which are hereby incorporated by reference. This network is a 5-stages fully-convolutional network, based on LeNet architecture. It is relatively shallow and with a small receptive field of only 32×32, as it only needs to find local defocus cues rather than understanding of a global context. The phase-encoded monocular network was trained using a synthetic dataset described below. Since it relies on local cues encoded by the phase mask, it generalizes well to real-world data though it is trained only on simulated data. Another type of monocular depth estimation network (referred to herein as network 3) is the image-based monocular network described in [Lasinger et al. 2019], the contents of which are hereby incorporated by reference. This network was trained on a wide variety of datasets and showed better generalization abilities than other monocular methods that have been tested. The network is based on ResNet multi-scale architecture.

The online self-calibration method of the present embodiments is shown herein using stereo combined with either network 3 or network 2. Stereo depth improvement is demonstrated using network 2.

To demonstrate the phase-coded mask method, masks were incorporated in both lenses of a stereo camera. The mask estimated ψ parameter spreads a range of depths around the focus point and it is most accurate in its proximity. The left camera's lens focus point was set to be 1.5 m in front of it, to allow a broader distance range to be covered by the ψ parameter, and 0.7 m for the right camera, to allow finer depth estimation in the close distance range. Using such a setting, the acquired monocular depth estimation of the left camera covers a relatively broad range of depths of 0.56 m to 4.5 m, and therefore can serve as a proper reference for the self-calibration process, for scenes within the above depths range. The acquired monocular depth estimation of the right camera covers a narrower range of depths, 0.39 m to 1.0 m, but more accurately, hence can compensate for the low stereo accuracy in these ranges.

The stereo network can be used with images taken with the phase mask, as the experiments show that the depth cues embedded by the phase-coded aperture imaging do not affect the quality of the stereo method, due to its global nature that ignores the phase-masks local optical cues.

The technique of the present embodiments is tested on three different types of scenes: simulated images (with full ground truth), images taken using a prototype system assembled according to some embodiments of the present invention for the experiments (qualitative comparison), and the uncalibrated version of the KITTI dataset (sparse ground truth acquired using LiDAR). The latter is only tested for self-calibration, due to its far distance ranges.

Stereo Camera Online Self Calibration

The training of the calibration block (DPT) in the technique of the present embodiments was done using a pair of images for 100 gradient descent steps (as there is only one input pair, there is no meaning to SGD considerations). Additional visual examples for each part of our experiments are provided hereinunder.

The self-calibration method of the present embodiments is initially tested using simulated images. Synthetic scenes containing both high-quality RGB images and their pixel-wise accurate corresponding depth maps were created using the Blender software. The dataset consists of 500 pairs of rectified stereo images (with a baseline of 10 cm) and their depth maps. A proper imaging simulation process is applied to the images, modeling the phase-coded mask and depth-dependent imaging effects.

Since the generated images are perfectly rectified, calibration error is introduced by transforming the left images in the dataset using an arbitrary projective transformation. The technique of the present embodiments was then used to find the inverse projective transformation that achieves monocular-stereo depth consistency.

The self-calibration performances using the phase-coded and the image-based monocular methods were compared. For reference, the performance was compared to a feature extraction based self-calibration method (DSR) [Xiao et al. 2018]. The test images used included an arbitrary rotation and translation. Comparison is presented for the L1 and the relative-L1 difference between the stereo depth map after calibration, and ground-truth depth map.

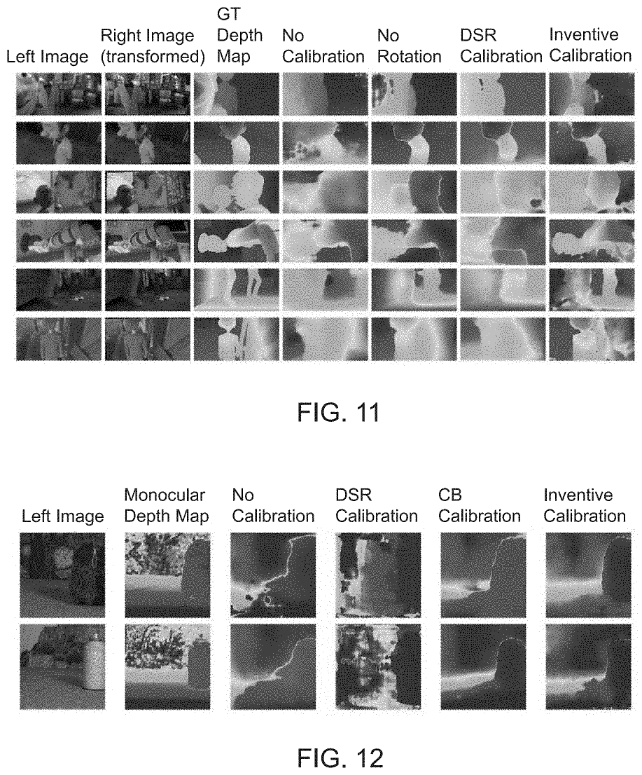

Table 1 lists the L1 and the relative-L1 difference between stereo depth maps and ground truth depth maps on the synthetic dataset, before calibration, and after calibration using the DSR method, the image-based method, and the phase-coded method. The upper row in Table 1 represents the perfect calibration, since the synthetic images are perfectly rectified. Note that the method of the present embodiments with both phase-coded and image-based networks (two last rows in Table 1) shows significant superior performance over the other calibration techniques. Note also that the phase-coded aperture based calibration achieves better results compared to the image-based method. Visual examples are provided hereinunder (see FIG. 11).

TABLE 1

| Method | L1 | Rel-L1 |
|---|---|---|
| No Rotation | 0.59 | 0.19 |
| Before Calibration | 2.02 | 0.56 |
| DSR | 1.67 | 0.45 |
| Image-based | 0.92 | 0.28 |
| Phase-coded | 0.84 | 0.22 |

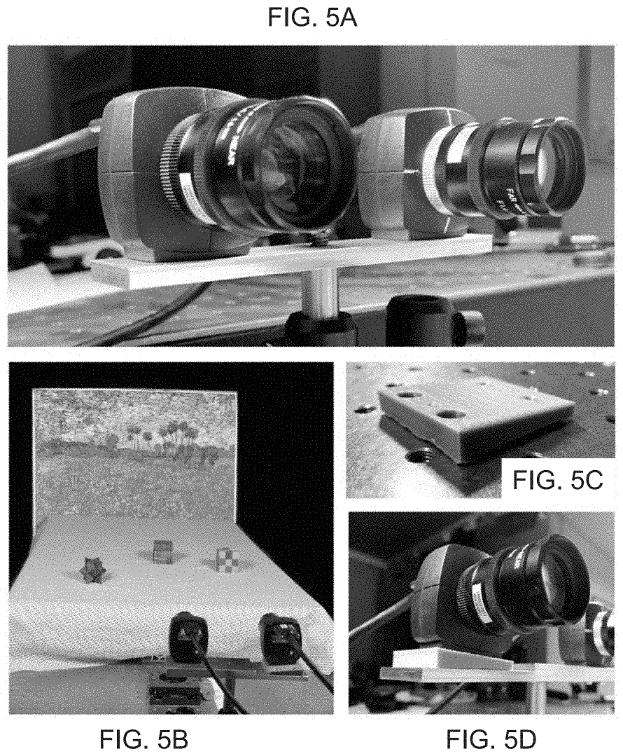

Images of the prototype system used in this Example are shown in FIGS. 5A-D. FIG. 5A shows the stereo set, with a phase-encoded mask applied on the left camera, FIG. 5B shows an indoor test scene example, FIGS. 5C and 5D show an additional 5 degrees image plane rotation that was applied to the right camera, to test the calibration method of the present embodiments on such deviations. The system is based on two IDS3590 18MP cameras equipped with KOWA LM16JCM-V lenses (with f=16 mm focal length) and a phase aperture-coding mask. The cameras are mounted as a stereo pair with a 10 cm baseline.

The stereo set was first calibrated using checkerboards calibration targets (referred to herein as CB calibration), and was then artificially transformed to simulate a known out-of-calibration state. After showing that the artificially introduced transformation can be obtained, the prototype system was tested on a realistic scenario, without any calibration, using the two images of both cameras mounted on a generally planar base. Since the cameras are mounted on a rigid base with a known baseline, they are not far from being calibrated. However, trying to get a proper depth map from the raw images, without any calibration, results in a wrong depth map. In accordance with some embodiments of the present invention, the right image was rectified to the left image by training the DPT parameters (using a pair of images taken with the prototype system) to achieve mono-stereo depth estimation consistency. The calibration results are shown qualitatively. Examples for our results for the two cases, on both the artificial transformation and the calibration of the two mounted cameras, are provided hereinunder (see FIG. 12).

In an additional test a rotation of 5 degrees in the image plane of one of the cameras was then applied (FIGS. 5C and 5D). This checks the ability of the technique of the present embodiments to find the correct calibration when the camera set is initially far from being calibrated.

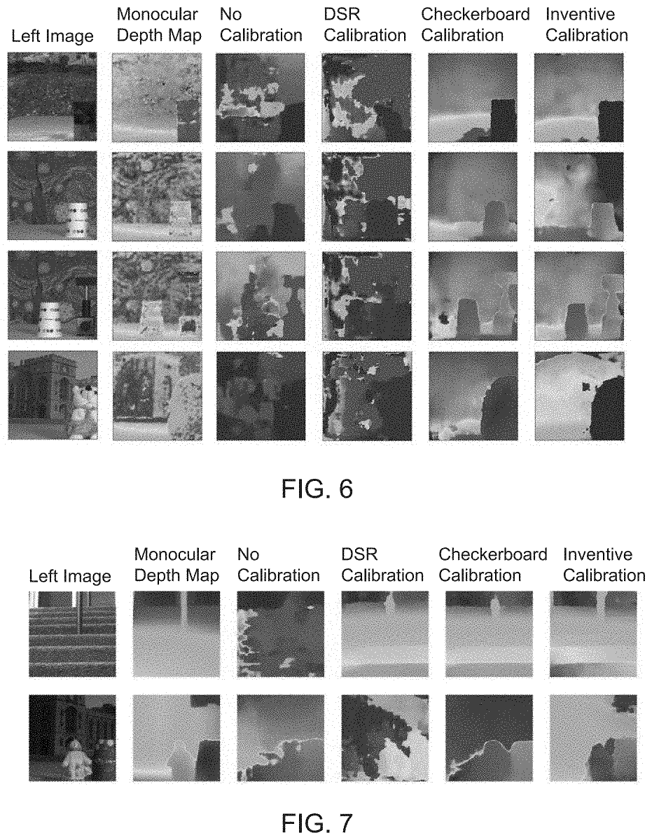

FIG. 6 is a set of images showing depth estimation of real-world images after calibration with DSR (feature-based), CB calibration and the method of the present embodiments, using phase-coded depth estimation. A set of images showing auto-calibration examples using the image-based monocular method is shown in FIG. 7. Using the monocular depth map as a reference, the system auto-calibrates itself.

Note that the method of the present embodiments (rightmost columns in FIGS. 6 and 7) successfully corrects the relatively high deviation of an additional 5 degrees rotation to the uncalibrated stereo set, and calibrate the system properly. Its resulted depth is on par with the checkerboard outcome. Also note that the DSR calibration was not able to rectify the images properly.

The first row of FIG. 7 shows an example in which the inventive calibration method performs even better than the checkerboard calibration, see the rod on the upper side of the image, which appears correctly only in the depth map of the rightmost column. In some cases, the monocular method errors bleed into the stereo map (see the spots on the flat background poster in the second row of FIG. 7).

In an additional experiment, the calibration method of the present embodiments was applied to uncalibrated KITTI dataset images [Geiger et al. 2013], and the results were compare it the CB calibration. In this experiment, only the image-based monocular method was used.

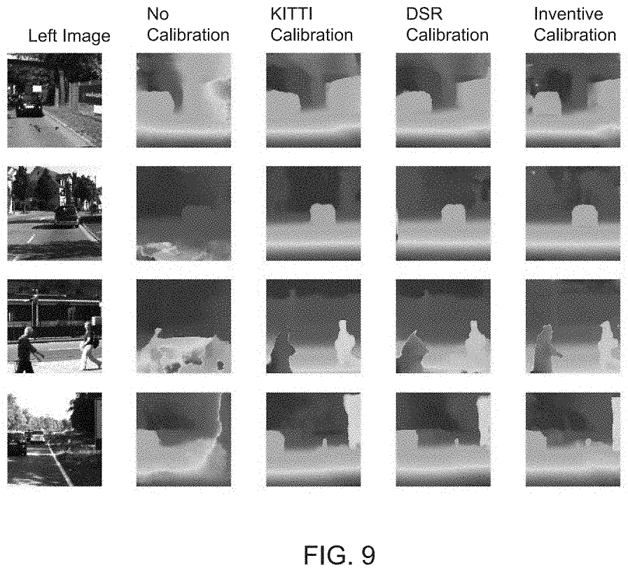

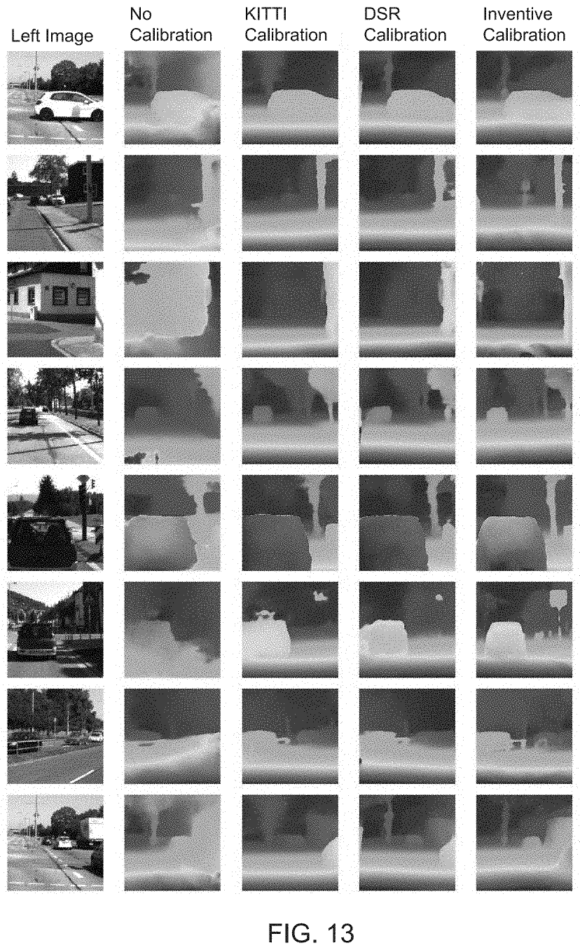

Table 2, below, lists comparison of the L1 distance between the depth maps obtained using the stereo network and the rectified KITTI ground-truth depth for: (i) the original KITTI images before calibration, (ii) the calibrated KITTI images (achieved using conventional checkerboard calibration), (iii) DSR (feature-based calibration), and (iv) the calibration according to some embodiments of the present invention. As demonstrated, the method of the present embodiments achieves better results than the DSR method, and comparable results to the conventional checkerboard calibration. Some example results are shown in FIG. 9. Additional examples are provided hereinunder (see FIG. 13).

TABLE 2

| Method | L1 | Rel. L1 | Rel. L2 | RMSE |
|---|---|---|---|---|
| CB Calibration | 1.86 | 0.07 | 0.20 | 2.25 |
| Before Calibration | 6.22 | 0.32 | 3.62 | 8.10 |
| DSR Calibration | 4.73 | 0.25 | 1.79 | 5.75 |
| Inventive Calibration | 2.11 | 0.11 | 0.46 | 2.87 |

As the stereo network is pre-trained and frozen, and our training includes only the DPT parameters, the training process is fast. It sufficient to train using a small number of pair of images. In this Example, only one pair of images was used, and training included only 100 gradient steps. An SGD optimizer and learning rate of 1e-4 were used. The calibration point was selected to be a point in which the loss between the depth maps was minimal. Since the aim was to decrease the difference between the depth maps, the absolute scale of the difference has little meaning. Hence, the normalized difference between the depth maps was calculated by dividing each training process with the maximal difference value (which is usually in the first training step).

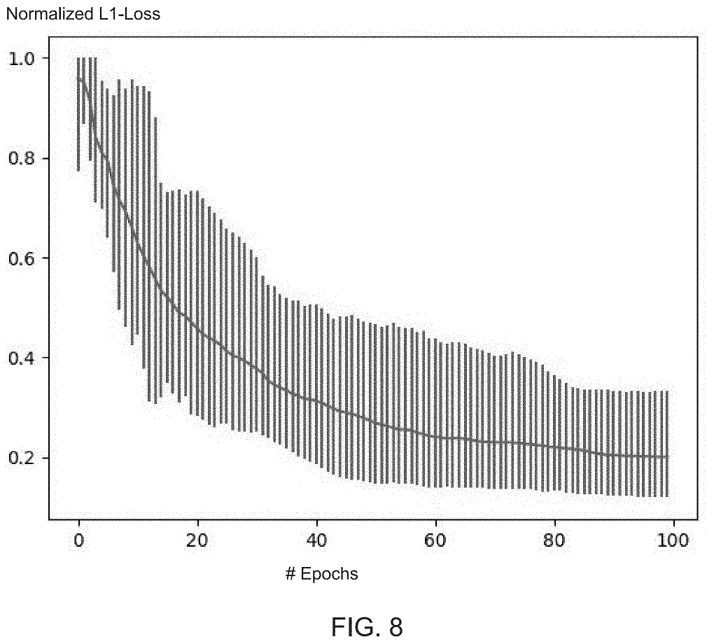

FIG. 8 shows the normalized minimum, maximum and mean training loss for the KITTI raw dataset per epoch, for 100 gradient steps. Each gradient step lasts 100-200 ms on a Nvidia 2080Ti GPU (depending on the input image size, the typical image size in this Example was 256×256), hence the entire training time was about 10 sec.

Improving Depth Estimation

The stereo method shows inferior results in the proximate ranges, while phase-coded monocular depth estimation can be tuned to be most accurate on a desired specific range. Thus, a camera with a focus point of 0.7 m was used, so that the phase-coded based depth reconstruction is most accurate in the ranges of 0.39-1 m, where the stereo method suffers from the largest relative error. As FIG. 4 shows, the monocular estimation is substantially better in this depth range.

A threshold was used to generate a binary mask to combine the monocular and stereo depth maps. Since the point in which each method is more accurate is known, the threshold can be set in advance to achieve best accuracy in the overall depth map. The advantages of using a threshold in this case is that in is not affected by generalization issues.

Table 3, below, compares the fused depth to the monocular and stereo depths. The results are shown on simulated data that have ground truth depth maps. The fused depth map shows an improvement of 10% in the relative L1-loss, measured between the depth estimation and the depth ground truth. The relative L1-Mask column shows the loss only for the ranges covered by the monocular method, in the present experiment for depth less than 1 m.

TABLE 3

| Method | Rel. L1 | Rel. L1-Mask | Rel. L2 | RMSE |
|---|---|---|---|---|
| Stereo | 0.065 | 0.169 | 0.87 | 4.21 |
| Mono | 0.551 | 0.117 | 16.98 | 14.1 |
| Fused | 0.059 | — | 0.819 | 4.1 |

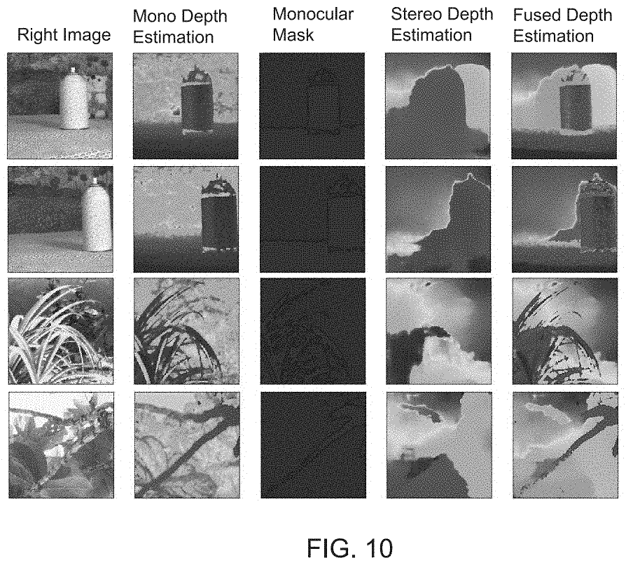

Examples of fusion of Stereo and Mono depth maps are shown in FIG. 10. The first two rows in FIG. 10 show examples of a table with a close spray-bottle on it. The monocular method is able to accurately estimate the gradual depth of the table and the bottle, while the stereo method estimates the background better. In the two last rows of FIG. 10, the fused depth maps add objects from the monocular depth map that are not properly perceived in the stereo depth map due to their proximity.

It is noted that the contrast of the acquired image may decrease when applying the phase-coded mask monocular solution. Indeed, the image may be blindly de-blurred using the knowledge of the PSF model. A clear image reconstruction can be achieved by post-processing, as presented in, for example, [Krishnan et al. 2011; Haim et al. 2015; Elmalem et al. 2018], the contents of which are hereby incorporated by reference. It is also noted that the de-blurred image exhibits an extended depth-of-field.

Another consideration when using the phase-coded depth estimation method is its good depth estimation in a relatively narrow range of depths. When a significant amount of the information in the images is out of the range to which the phase-coded mask is designed (−4≤ψ≤10, in the present Example), the image-based monocular method, which is not limited to a close range, is preferred, as demonstrated on the KITTI dataset.

The following equations were used to calculate the metrics used in this Example. In the following equation, “pred” denotes a prediction, and “gt” denotes ground truth data.

$${L 1}_{loss} = \frac{1}{T} {\sum }_{i = 1}^{T} \vert {pred}_{i} - {gt}_{i} \vert \\ Relative {L 1}_{loss} = \frac{1}{T} {\sum }_{i = 1}^{T} \frac{\vert {pred}_{i} - {gt}_{i} \vert}{{gt}_{i}} \\ Relative {L 2}_{loss} = \frac{1}{T} {\sum }_{i = 1}^{T} \frac{{( {pred}_{i} - {gt}_{i} )}^{2}}{{gt}_{i}} \\ Root Mean Square Error ( RMSE ) = \sqrt{\frac{1}{T} {\sum }_{i = 1}^{T} {( {pred}_{i} - {gt}_{i} )}^{2}}$$

Additional visual examples for the experiments described in this Examples are provided in FIGS. 11-14.

FIG. 11 is a set of images showing online-calibration results on a dataset synthetic images. The right image in each pair was rotated by 2 degrees, enough to significantly degrade the stereo network results. From left to right: RGB left images, RGB rotated right images, depth map ground truth, and depth results of the stereo network on a pair of images that is: before calibration, non-transformed (with the original right image), calibrated using DSR, and calibrated using the self-calibrating method of the present embodiments. As shown, the technique of the present embodiments is able to find the opposite transformation to rectify the images to achieve optimal results of the stereo network.

FIG. 12 is a set of images showing examples of online-calibration results on real-world images, using cameras mounted on a rigid base with a known baseline. The cameras were relatively close to being calibrated, as they are mounted on a rigid base with a known baseline, and yet the results without any calibration are significantly worse (as seen in the “No Calibration” column). From left to right: RGB left images, phase-coded monocular depth maps, the depth results of the stereo network on a pair of images that is: non-calibrated, calibrated using DSR, calibrated using a CB calibration, and using the self-calibrating method of the present embodiments. As shown, the technique of the present embodiments is on par with the conventional CB calibration method.

FIG. 13 is a set of images showing additional Examples of calibration on the KITTI uncalibrated dataset. From left to right: RGB left images, the depth results of the stereo network on a pair of images that is: non-calibrated, calibrated set from KITTI dataset, calibrated using DSR, and calibrated using the self-calibrating method of the present embodiments. As shown, the technique of the present embodiments is on par and in some cases even better than the KITTI calibration, using the conventional CB calibration method. For example, in the second and the sixth row, the sign in the background is only visible with calibration according to some embodiments of the present invention. In rows 2, 3 and 5, the objects' boundaries are more crisp and clear using the calibration technique of the present embodiments.

FIG. 14 is a set of images showing examples of online-calibration on real-world images, after calibrating with a checkerboard target, and applying a 2-degree rotation on the calibrated results. From left to right: RGB left images, phase-coded monocular depth maps, depth results of the stereo network on a pair of images that is: non-calibrated, calibrated using DSR, calibrated using CB calibration, and using the self-calibrating method of the present embodiments. As shown, the technique of the present embodiments achieves even more accurate results than the conventional CB calibration.

### CONCLUSION

This Example described an approach for combining monocular depth cues and stereo disparity information is proposed. It allows avoiding the need for a costly and sensitive calibration process, and also to improving the overall depth estimation results. While the system is trained on simulated data, both of its features are examined in simulation as well as in real-world experiments. Note that no fine-tuning on real world images is done (after training on simulated images), which demonstrates the generalization and robustness of the system to various environments.

The calibration approach of the present embodiments was demonstrated using two types of monocular depth estimation techniques: a phase-coded technique and an image-based technique. While both techniques achieve comparable results to CB calibration, a more robust calibration process was observed when using the phase-coded technique.

The calibration scheme presented in this Example outperforms other online calibration techniques. Its advantage over them is its global nature that lies in the requirement for mono-stereo depth consistency and the usage of already-existing monocular depth estimation networks, which include strong priors for natural images.

This Example presented a depth improvement method using the phase-coded technique. This Example demonstrated how using a depth map obtained with a phase-coded mask can improve a stereo depth map accuracy by 10% overall, especially in the close-range in which the stereo strategy struggles.

The technique of the present embodiments can be applied also to sequence of images taken with a single camera from different points of view. In this case, the auto-calibration procedure of the present embodiments provides a fast and reliable calibration for each image pair, in order to produce a full 3D model of the captured scene. The technique of the present embodiments can be applied also for depth estimation when using different sensors.

Although the above Example presented both extended depth range and auto-calibration, each of these features can be achieved separately depending on the desired application. To use the phase-coded monocular method, only one of the stereo cameras can be equipped with a phase mask, and can be used for either improving the depth accuracy or for auto-calibration. In this case, the clear aperture camera, which is used for the stereo depth, provides a conventional high-contrast image.

The technique of the present embodiments can be applied with any passive or active depth estimation approaches, not necessarily using a stereo camera, and not necessarily using the phase-coded and image-based monocular depth estimations used in this Example.

In addition, any priority document(s) of this application is/are hereby incorporated herein by reference in its/their entirety.

### REFERENCES

Amlaan Bhoi. 2019. Monocular Depth Estimation: A Survey. CoRR abs/1901.09402 (2019).

Marcela Carvalho, Bertrand Le Saux, Pauline Trouve-Peloux, Andres Almansa, and Frederic Champagnat. 2018. Deep Depth from Defocus: how can defocus blur improve 3D estimation using dense neural networks?. In The European Conference on Computer Vision (ECCV) Workshops.

Ayan Chakrabarti and Todd Zickler. 2012. Depth and deblurring from a spectrally-varying depth-of-field. In Computer Vision—ECCV 2012. Springer, 648-661.

Julie Chang and Gordon Wetzstein. 2019. Deep Optics for Monocular Depth Estimation and 3D Object Detection. CoRR abs/1904.08601 (2019).

Jia-Ren Chang and Yong-Sheng Chen. 2018. Pyramid Stereo Matching Network. In Proceedings of the IEEE Conference on Computer Vision and Pattern Recognition. 5410-5418.

Xinjing Cheng, Peng Wang, and Ruigang Yang. 2018. Learning Depth with Convolutional Spatial Propagation Network. CoRR abs/1810.02695 (2018). arXiv:1810.02695.

Brian Curless and Marc Levoy. 1996. A Volumetric Method for Building Complex Models from Range Images. In Proceedings of the 23rd Annual Conference on Computer Graphics and Interactive Techniques (SIGGRAPH '96). ACM, New York, N.Y., USA, 303-312. www(dot)doi(dot)org/10(dot)1145/237170.237269

Angela Dai and Matthias Nießner. 2018. 3DMV: Joint 3D-Multi-View Prediction for 3D Semantic Scene Segmentation. ArXiv abs/1803.10409 (2018).

T. Dang, C. Hoffmann, and C. Stiller. 2009. Continuous Stereo Self-Calibration by Camera Parameter Tracking. IEEE Transactions on Image Processing 18, 7 (July 2009), 1536-1550.

T. Darrell and K. Wohn. 1988. Pyramid based depth from focus. In Proceedings CVPR '88: The Computer Society Conference on Computer Vision and Pattern Recognition. 504-509. www(dot)doi(dot)org/10.1109/CVPR.1988.196282

Xianzhi Du, Mostafa El-Khamy, and Jungwon Lee. 2019. AMNet: Deep Atrous Multiscale Stereo Disparity Estimation Networks. CoRR abs/1904.09099 (2019).

David Eigen, Christian Puhrsch, and Rob Fergus. 2014. Depth Map Prediction from a Single Image using a Multi-Scale Deep Network. In Advances in Neural Information Processing Systems 27, Z. Ghahramani, M. Welling, C. Cortes, N. D. Lawrence, and K. Q. Weinberger (Eds.). Curran Associates, Inc., 2366-2374. www(dot)papers(dot)nips(dot)cc/paper/5539-depth-map-prediction-from-a-single-image-using-a-multi-scale-deep-network(dot)pdf

Shay Elmalem, Raja Giryes, and Emanuel Marom. 2018. Learned phase coded aperture for the benefit of depth of field extension. Opt. Express 26, 12 (June 2018), 15316-15331. www(dot)doi(dot)org/10.1364/OE.26.015316

Ravi Garg, B. G. Vijay Kumar, Gustavo Carneiro, and Ian D. Reid. 2016. Unsupervised CNN for Single View Depth Estimation: Geometry to the Rescue. In Computer Vision—ECCV 2016—14th European Conference, Amsterdam, The Netherlands, Oct. 11-14, 2016, Proceedings, Part VIII. 740-756.

Andreas Geiger, Philip Lenz, Christoph Stiller, and Raquel Urtasun. 2013. Vision meets Robotics: The KITTI Dataset. International Journal of Robotics Research (IJRR) (2013).

R. Georg Mueller, P. Burger, and H. Wuensche. 2018. Continuous Stereo Self-Calibration on Planar Roads. In 2018 IEEE Intelligent Vehicles Symposium (IV). 1755-1760. www(dot)doi(dot)org/10.1109/IVS.2018.8500487

Clement Godard, Oisin Mac Aodha, and Gabriel J. Brostow. 2017. Unsupervised Monocular Depth Estimation With Left-Right Consistency. In The IEEE Conference on Computer Vision and Pattern Recognition (CVPR).

Matan Goldman, Tal Hassner, and Shai Avidan. 2019. Learn Stereo, Infer Mono: Siamese Networks for Self-Supervised, Monocular, Depth Estimation. In Computer Vision and Pattern Recognition Workshops (CVPRW).

Ariel Gordon, Hanhan Li, Rico Jonschkowski, and Anelia Angelova. 2019. Depth from Videos in the Wild: Unsupervised Monocular Depth Learning from Unknown Cameras. In The IEEE International Conference on Computer Vision (ICCV).

Vitor Campanholo Guizilini, Rares Ambrus, Sudeep Pillai, and Adrien Gaidon. 2019. PackNet-SfM: 3D Packing for Self-Supervised Monocular Depth Estimation. ArXiv abs/1905.02693 (2019).

Xinqing Guo, Zhang Chen, Siyuan Li, Yang Yang, and Jingyi Yu. 2017. Deep Depth Inference using Binocular and Monocular Cues. CoRR abs/1711.10729 (2017). arXiv:1711.10729

Shir Gur and Lior Wolf. 2019. Single Image Depth Estimation Trained via Depth from Defocus Cues. In IEEE Conference on Computer Vision and Pattern Recognition (CVPR).

Uwe Hahne and Marc Alexa. 2008. Combining Time-Of-Flight Depth and Stereo Images without Accurate Extrinsic Calibration. Int. J. Intell. Syst. Technol. Appl. 5, 3/4 (November 2008), 325-333. www(dot)doi(dot)org/10.1504/IJISTA.2008.021295

Harel Haim, Alex Bronstein, and Emanuel Marom. 2015. Computational multi-focus imaging combining sparse model with color dependent phase mask. Opt. Express 23, 19 (September 2015), 24547-24556. www(dot)doi(dot)org/10.1364/OE.23.024547

Harel Haim, Shay Elmalem, Raja Giryes, Alex Bronstein, and Emanuel Marom. 2018. Depth Estimation from a Single Image using Deep Learned Phase Coded Mask. IEEE Transactions on Computational Imaging (2018), 298-310. www(dot)doi(dot)org/10.1109/TCI.2018.2849326

R. Hartley, R. Gupta, and T. Chang. 1992. Stereo from uncalibrated cameras. In Proceedings 1992 IEEE Computer Society Conference on Computer Vision and Pattern Recognition. 761-764. www(dot)doi(dot)org/10.1109/CVPR.1992.223179

Richard I. Hartley. 1997. In Defense of the Eight-Point Algorithm. IEEE Trans. Pattern Anal. Mach. Intell. 19, 6 (1997), 580-593. www(dot)doi(dot)org/10.1109/34.601246

Hazirbas, S. Soyer, M. Staab, L. Leal-Taixé, and D. Cremers. 2018. Deep Depth From Focus. In ACCV.

Herrera, C. J. Kannala, and J. Heikkila. 2016. Forget the checkerboard: Practical self-calibration using a planar scene. In 2016 IEEE Winter Conference on Applications of Computer Vision (WACV). 1-9. www(dot)doi(dot)org/10.1109/WACV.2016.7477641

G. Iyer, R. K. Ram, J. K. Murthy, and K. M. Krishna. 2018. CalibNet: Geometrically Supervised Extrinsic Calibration using 3D Spatial Transformer Networks. In 2018 IEEE/RSJ International Conference on Intelligent Robots and Systems (IROS). 1110-1117. www(dot)doi(dot)org/10.1109/IROS.2018.8593693 Shahram Izadi, David Kim, Otmar Hilliges, David Molyneaux, Richard Newcombe, Pushmeet Kohli, Jamie Shotton, Steve Hodges, Dustin Freeman,

Andrew Davison, and Andrew Fitzgibbon. 2011. KinectFusion: Real-time 3D Reconstruction and Interaction Using a Moving Depth Camera. In Proceedings of the 24th Annual ACM Symposium on User Interface Software and Technology (UIST '11). ACM, New York, N.Y., USA, 559-568. www(dot)doi(dot)org/10.1145/2047196.2047270

Max Jaderberg, Karen Simonyan, Andrew Zisserman, and koray kavukcuoglu. 2015. Spatial Transformer Networks. In Advances in Neural Information Processing Systems 28, C. Cortes, N. D. Lawrence, D. D. Lee, M. Sugiyama, and R. Garnett (Eds.). Curran Associates, Inc., 2017-2025. www(dot)papers(dot)nips(dot)cc/paper/5854-spatial-transformer-networks.pdf

Young Kim, Christian Theobalt, James Diebel, J. Kosecka, Branislav Micusik, and Sebastian Thrun. 2009. Multi-view Image and ToF Sensor Fusion for Dense 3D Reconstruction. 2009 IEEE 12th International Conference on Computer Vision Workshops, ICCV Workshops 2009, 1542-1549. www(dot)doi(dot)org/10.1109/ICCVW.2009.5457430

D. Krishnan, T. Tay, and R. Fergus. 2011. Blind deconvolution using a normalized sparsity measure. In CVPR. 233-240.

Katrin Lasinger, Rene Ranftl, Konrad Schindler, and Vladlen Koltun. 2019. Towards Robust Monocular Depth Estimation: Mixing Datasets for Zero-Shot Cross-Dataset Transfer. CoRR abs/1907.01341 (2019). arXiv:1907.01341

Anat Levin, Rob Fergus, Frédo Durand, and William T. Freeman. 2007. Image and Depth from a Conventional Camera with a Coded Aperture. In ACM SIGGRAPH 2007 Papers (SIGGRAPH '07). ACM, New York, N.Y., USA, Article 70. www(dot)doi(dot)org/10.1145/1275808.1276464

Haiting Lin, Can Chen, Sing Bing Kang, and Jingyi Yu. 2015. Depth Recovery From Light Field Using Focal Stack Symmetry. In The IEEE International Conference on Computer Vision (ICCV).

X. Lin, J. Suo, G. Wetzstein, Q. Dai, and R. Raskar. 2013. Coded focal stack photography. In IEEE International Conference on Computational Photography (ICCP). 1-9. www(dot)doi(dot)org/10.1109/ICCPhot.2013.6528297

F. Liu, C. Shen, G. Lin, and I. Reid. 2016. Learning depth from single monocular images using deep convolutional neural fields. IEEE Transactions on Pattern Analysis and Machine Intelligence (2016). www(dot)dx(dot)doi(dot)org/10.1109/TPAMI.2015.2505283

H. C. Longuet Higgins. 1981. A Computer Algorithm for Reconstructing a Scene from Two Projections. Nature 293 (1981).

Wenjie Luo, Alexander G. Schwing, and Raquel Urtasun. 2016. Efficient Deep Learning for Stereo Matching. 2016 IEEE Conference on Computer Vision and Pattern Recognition (CVPR) (2016), 5695-5703.

Joseph N. Mait, Gary W. Euliss, and Ravindra A. Athale. 2018. Computational imaging. Adv. Opt. Photon. 10, 2 (June 2018), 409-483. www(dot)doi(dot)org/10.1364/AOP.10.000409

Manuel Martinello, Andrew Wajs, Shuxue Quan, Hank Lee, Chien Lim, Taekun Woo, Wonho Lee, Sang-Sik Kim, and David Lee. 2015. Dual Aperture Photography: Image and Depth from a Mobile Camera. (April 2015).

Rahul Nair, Kai Ruhl, Frank Lenzen, Stephan Meister, Henrik Schäfer, Christoph S. Garbe, Martin Eisemann, Marcus Magnor, and Daniel Kondermann. 2013. A Survey on Time-of-Flight Stereo Fusion. Springer Berlin Heidelberg, Berlin, Heidelberg, 105-127.

Pushmeet Kohli Nathan Silberman, Derek Hoiem and Rob Fergus. 2012. Indoor Segmentation and Support Inference from RGBD Images. In ECCV.

Sudeep Pillai, Rares Ambrus, and Adrien Gaidon. 2018. SuperDepth: Self-Supervised, Super-Resolved Monocular Depth Estimation. 2019 International Conference on Robotics and Automation (ICRA) (2018), 9250-9256.

Matteo Poggi, Fabio Tosi, and Stefano Mattoccia. 2018. Learning Monocular Depth Estimation with Unsupervised Trinocular Assumptions. 2018 International Conference on 3D Vision (3DV) (2018), 324-333.

Benjamin Resch, Jian Wei, and Hendrik Lensch. 2017. Real Time Direct Visual Odometry for Flexible Multi-camera Rigs. Lecture Notes in Computer Science (including subseries Lecture Notes in Artificial Intelligence and Lecture Notes in Bioinformatics) 10114, 503-518. www(dot)doi(dot)org/10.1007/978-3-319-54190-7_31

Gernot Riegler, Ali Osman Ulusoy, Horst Bischof, and Andreas Geiger. 2017. OctNetFusion: Learning Depth Fusion from Data. In 2017 International Conference on 3D Vision, 3DV 2017, Qingdao, China, Oct. 10-12, 2017. 57-66.

Ashutosh Saxena, Min Sun, and Andrew Y. Ng. 2009. Make3D: Learning 3D Scene Structure from a Single Still Image. IEEE Trans. Pattern Anal. Mach. Intell. 31, 5 (May 2009), 824-840. www(dot)doi(dot)org/10.1109/TPAMI.2008.132

Yoav Y. Schechner and Nahum Kiryati. 2000. Depth from Defocus vs. Stereo: How Different Really Are They? International Journal of Computer Vision 39, 2 (1 Sep. 2000), 141-162. www(dot)doi(dot)org/10.1023/A:1008175127327

Nick Schneider, Florian Piewak, Christoph Stiller, and Uwe Franke. 2017. RegNet: Multimodal sensor registration using deep neural networks. 2017 IEEE Intelligent Vehicles Symposium (IV) (2017), 1803-1810.

Prasan A. Shedligeri, Sreyas Mohan, and Kaushik Mitra. 2017. Data Driven Coded Aperture Design for Depth Recovery. CoRR abs/1705.10021 (2017). arXiv:1705.10021

N. Silberman and R. Fergus. 2011. Indoor Scene Segmentation using a Structured Light Sensor. In Proceedings of the International Conference on Computer Vision—Workshop on 3D Representation and Recognition.

Nikolai Smolyanskiy, Alexey Kamenev, and Stanley T. Birchfield. 2018. On the Importance of Stereo for Accurate Depth Estimation: An Efficient Semi-Supervised Deep Neural Network Approach. 2018 IEEE/CVF Conference on Computer Vision and Pattern Recognition Workshops (CVPRW) (2018), 1120-11208.

Supasorn Suwajanakorn, Carlos Hernandez, and Steven M. Seitz. 2015. Depth From Focus With Your Mobile Phone. In The IEEE Conference on Computer Vision and Pattern Recognition (CVPR).

Pauline Trouvé, Frédéric Champagnat, Guy Le Besnerais, Jacques Sabater, Thierry Avignon, and Jérôme Idier. 2013. Passive depth estimation using chromatic aberration and a depth from defocus approach. Appl. Opt. 52, 29 (October 2013), 7152-7164. www(dot)doi(dot)org/10.1364/AO.52.007152

Benjamin Ummenhofer, Huizhong Zhou, Jonas Uhrig, Nikolaus Mayer, Eddy Ilg, Alexey Dosovitskiy, and Thomas Brox. 2017. DeMoN: Depth and Motion Network for Learning Monocular Stereo. In The IEEE Conference on Computer Vision and Pattern Recognition (CVPR).

Yicheng Wu, Vivek Boominathan, Huaijin Chen, Aswin C. Sankaranarayanan, and Ashok Veeraraghavan. 2019. PhaseCam3D—Learning Phase Masks for Passive Single View Depth Estimation. In IEEE Intl. Conf. Computational Photography (ICCP).

Ruichao Xiao, Wenxiu Sun, Jiahao Pang, Qiong Yan, and Jimmy Ren. 2018. DSR: Direct Self-rectification for Uncalibrated Dual-lens Cameras. 3DV (2018).

Zhichao Yin, Trevor Darrell, and Fisher Yu. 2018. Hierarchical Discrete Distribution Decomposition for Match Density Estimation. CoRR abs/1812.06264 (2018). arXiv:1812.06264

Jure Zbontar and Yann LeCun. 2015. Computing the stereo matching cost with a convolutional neural network. 2015 IEEE Conference on Computer Vision and Pattern Recognition (CVPR) (2015), 1592-1599.

Feihu Zhang, Victor Prisacariu, Ruigang Yang, and Philip Ton. 2019. GA-Net: Guided Aggregation Net for End-to-end Stereo Matching. In Proceedings of the IEEE Conference on Computer Vision and Pattern Recognition (CVPR).

Changyin Zhou, Oliver Cossairt, and Shree K. Nayar. 2010. Depth from Diffusion. In IEEE Conference on Computer Vision and Pattern Recognition (CVPR).

Changyin Zhou, Stephen Lin, and Shree K. Nayar. 2011. Coded Aperture Pairs for Depth from Defocus and Defocus Deblurring. International Journal on Computer Vision 93, 1 (May 2011), 53.

T. Zhou, M. Brown, N. Snavely, and D. G. Lowe. 2017. Unsupervised Learning of Depth and Ego-Motion from Video. In 2017 IEEE Conference on Computer Vision and Pattern Recognition (CVPR). 6612-6619.

J. Zhu, L. Wang, R. Yang, J. E. Davis, and Z. pan. 2011. Reliability Fusion of Time-of-Flight Depth and Stereo Geometry for High Quality Depth Maps. IEEE Transactions on Pattern Analysis and Machine Intelligence 33, 7 (July 2011), 1400-1414. www(dot)doi(dot)org/10.1109/TPAMI.2010.172

1. A system for depth estimation, comprising:
at least a first and a second depth estimation optical systems, each configured for receiving a light beam from a scene and estimating depths within said scene, wherein said first system is a monocular depth estimation optical system; and
an image processor, configured for receiving depth information from said first and second systems, and generating a depth map or a three-dimensional image of said scene based on said received depth information.

2. The system of claim 1, wherein said image processor is configured for fusing depth maps estimated by said first and said second system.

3. The system of claim 2, wherein said fusing is by thresholding wherein said image processor is configured for receiving depth estimations that are less than a predetermined depth threshold from said first system, and other depth estimations from said second system.

4. The system of claim 2, wherein said image processor is configured for calculating confidence values for depth estimations provided by said first and said second systems, wherein said fusing is based on said calculated confidence values.

5. The system according to claim 4, wherein said calculating comprises applying a machine learning procedure.

6. The system according to claim 1, wherein said first system comprises a lens, an optical mask, and an image processor, wherein said optical mask is characterized by at least one parameter, and wherein said image processor is configured for extracting from an image captured through said mask depth cues corresponding to said at least one parameter, and for estimating a depth map of said scene based on said extracted depth cues.

7. The system according to claim 1, wherein said second system comprises a passive depth estimation system.

8-12. (canceled)

13. The system according to claim 1, wherein said second system comprises an active depth estimation system.

14-18. (canceled)

19. The system according to claim 1, wherein said first system is selected from the group consisting of a light field imaging system, a structured light imaging system, and a time-of-flight imaging system, and said second system comprises a stereoscopic imaging system.

20. The system according to claim 1, wherein said second system comprises a stereoscopic imaging system generating a left image and a right image, and wherein said image processor is configured for rectifying one of said left and right images, but not another one of said right images.

21. (canceled)

22. The system according to claim 1, wherein said image processor is configured for calibrating depth estimations of said second system using depth estimations received from said first system.

23. (canceled)

24. The system according to claim 22, wherein said second system comprises a stereoscopic imaging system, wherein said image processor is configured for calculating consistency losses among depth maps estimated by said first and said second systems, and wherein said calibrating is based on said calculated consistency losses.

25-27. (canceled)

28. The system according to claim 1, wherein said second system comprises a stereoscopic imaging system, and wherein said image processor is configured to calculate consistency losses among depth maps estimated by said first and said second systems, and to generate an alert signal when said consistency losses are above a predetermined threshold.

29. (canceled)

30. The system according to claim 1, wherein at least one of said first and said second systems comprises a Dynamic Vision Sensor (DVS).

31. A method of depth estimation, comprising:
receiving a light beam from a scene and estimating depths within said scene, by two different depth estimation techniques, wherein at least one of said depth estimation technique is a monocular depth estimation technique; and
receiving depth information estimated by said two different depth estimation techniques, and generating a depth map or a three-dimensional image of said scene based on said received depth information.

32-48. (canceled)

49. A method of calibrating a stereoscopic imaging system, the method comprising:
receiving a stereoscopic image pair having a first image and a second image;
applying an image transformer to said first image to rectify said first image to said second image, thereby providing a rectified first image;
generating a monocular depth map from said first image;
generating a stereoscopic depth map pair having a first depth map corresponding to said rectified first image and a second depth map corresponding to said second image;
comparing said monocular depth map to said first depth map; and
calibrating said stereoscopic imaging system based on said comparison.

50. The method according to claim 49, wherein said generating said monocular depth map comprises applying a trained machine learning procedure to said first image.

51. The method according to claim 49, wherein said generating said stereoscopic depth map pair comprises applying a trained machine learning procedure to said rectified first image and said second image.

52. The method according claim 49, wherein said comparing comprises calculating a consistency loss among said monocular depth map and said first depth map.

53. (canceled)

54. (canceled)

55. The system according to claim 22, wherein said calibrating is based solely on consistency losses.
